(19) United States
(12) Patent Application Publication
(10) Pub. No.: US 2017/0039266 A1
(43) Pub. Date: Feb. 9, 2017

(54) METHODS AND SYSTEMS FOR MULTI-CODE CATEGORIZATION FOR COMPUTER-ASSISTED CODING

(71) Applicant: Ubiquiti Inc., Ann Arbor, MI (US)

(72) Inventors: Nandit Soparkar, Ann Arbor, MI (US); Kunal Joshi, Ann Arbor, MI (US); James Lee, Ann Arbor, MI (US); Vikram Parvathaneni, Ann Arbor, MI (US); Keith Thompson, Ann Arbor, MI (US); Jayadevan Vadake Kottattil, Ann Arbor, MI (US); Benjamin P. King, Ann Arbor, MI (US)

(73) Assignee: Ubiquiti Inc., Ann Arbor, MI (US)

(21) Appl. No.: 15/074,741

(22) Filed: Mar. 18, 2016

Related U.S. Application Data
(60) Provisional application No. 62/135,684, filed on Mar. 19, 2015.
(60) Provisional application No. 62/136,313, filed on Mar. 20, 2015.

(51) Int. Cl. G06F 17/30; G06Q 30/00; G06F 19/00

(52) U.S. Cl. CPC G06F 17/30598; G06F 19/328; G06Q 30/012

(57) ABSTRACT

Computer implemented methods and systems for assisting a user to select one or more codes from a set of available codes to categorize a record. The method includes (a) receiving information on a record to be categorized; (b) determining a set of multiple candidate codes to suggest to the user that is a subset of the set of available codes having a greater likelihood of accurately matching the applicability criteria for the codes for the record than other codes, the set of candidate codes including candidate code(s) selectable by the user to be assigned to the record among other possible candidate codes; (c) presenting the set of multiple suggested candidate codes to the user for assessment; (d) receiving a user selection input of a code or codes to be associated with the record; and (e) assigning the selected one or more codes to the record to categorize the record.

### CROSS REFERENCE TO RELATED APPLICATIONS

This application claims priority from U.S. Provisional Patent Application No. 62/135,684 filed on Mar. 19, 2015 entitled MULTI-CODE CATEGORIZATION FOR COMPUTER-ASSISTED CODING and from U.S. Provisional Patent Application No. 62/136,313 filed on Mar. 20, 2015 entitled METHODS AND SYSTEMS FOR MULTI-CODE CATEGORIZATION FOR COMPUTER-ASSISTED CODING. Both applications are hereby incorporated by reference.

### BACKGROUND

The present patent application relates generally to the categorization of records such as insurance and warranty claims records and, more particularly, to the computer-assisted coding of such records. As used herein, a record is a collection of one or more related items of information, where such items may be of different types. For example, a record for a hospital patient visit may include the patient name, the patient age, the patient social security number, some photographs, a hospital visit sequence number, an audio voice recording by the doctor documenting the visit, a picture of a chart from a laboratory test performed, a video recording of a procedure performed on the patient, etc. Also, a record may even resemble a much larger document as a whole. Several related records in a group may also be examined together for categorization, and a record should be considered to mean either a single record or a group of records, as appropriate to the context.

Ia: Categorizing records is an important business activity. Such categorization includes efforts colloquially called “sorting” or “binning.” Categorizing a record is equivalent to assigning a category to the record. An example of a category is the diagnosis ascribed to a patient in a healthcare situation, as reported by a doctor in the patient record. Categories may be organized hierarchically, with a category having one or more sub-categories, each of which is also regarded as a category. For example, a respiratory ailment may be a diagnosis category in healthcare, with sub-categories being upper and lower respiratory tract ailments. Continuing with the example, the upper respiratory ailment category may have further sub-categories, such as the common cold, sinusitis and more. Similarly, the lower respiratory tract ailment may have sub-categories such as bronchitis, pneumonia and more. In this example, an ailment category such as influenza may be a sub-category of both upper and lower respiratory tract ailments, which illustrates the possibility that a category may be present under more than one containing category. When a record is assigned to a particular category, it is implicitly regarded as being assigned to all the containing categories up to the top of the category hierarchy. Usually, some applicability criteria are used to determine the appropriate category for each record. Such categorization applicability criteria may be known explicitly, implicitly, or be partly explicit or implicit. Often, the number of categories is large, and together with their applicability criteria, it makes it difficult for a human person to remember them all. For example, healthcare categories may number in the tens of thousands of categories. In a situation where it is permissible to assign a single category to a record, we refer to it as a situation of “single categorization.”

Ib: For some uses, each record may be categorized into multiple categories. That is, it may be permissible to assign more than one category to a record. For example, a patient record in healthcare may be categorized by the symptom categories that the patient exhibited as indicated by the record. Continuing with this example, there may be multiple symptom categories, such as coughing, fever and more, as were exhibited by the patient, and consequently, the corresponding symptom categories of coughing, fever etc. may be assigned to the patient record. In a situation where it is permissible to assign multiple (i.e., two or more) categories to a record, we refer to it as a situation of “multiple categorization.”

For some uses, the same record may be categorized using different categorization classes. In healthcare, such categorization classes are exemplified by symptom categories, diagnoses categories, procedure categories etc. Each categorization class usually has its own applicability criteria. Each such categorization class may be regarded as a separate instance of categorization described in the paragraphs above. Usually a record is processed for all relevant categorization classes together. This contrasts with processing a particular categorization or categorization class together for all records, followed by repeating the processing for each of the remaining relevant categorization or categorization classes similarly.

Ic: To categorize a record, a “code” or “codes” may be assigned to each record. Each code represents a category as described in the paragraphs above. As such, categorization is called “coding,” and records processed in this manner are said to be “coded.” Analogous to categorization classes, for some uses, each record may be coded into multiple code classes. A code class is a categorization class as described in paragraph Ib above. As used herein, the terms code, coding, coded, and code classes also mean category, categorization, categorized, and categorization classes, respectively.

Id: Often, coding of records is mostly a manual effort. Such manual coding can be slow and error-prone. Manual coding of records can be assisted by computers. For example, a computer database of available codes can help in manual coding. Such a database may include information on the applicability criteria for each code. Search utilities to look up codes exemplify simple uses of computers used to assist in coding. It is assumed that the simple uses of computers, such as computerized storage and search utilities to look up codes and their criteria for applicability, are utilized in manual coding of records. In contrast, “classification” techniques to suggest codes automatically exemplify more complex use of computers for coding. We refer to such more complex computer use in coding as “computer-assisted coding” or CAC. It takes negligible computer-time for most CAC to run on modern computers. It is manual coding that is time-consuming, even with simple uses of computers to assist in coding. Various embodiments disclosed herein are directed to making the human effort associated with CAC to be more efficient and effective than the current practices.

IIa: “Medical coding” exemplifies an important business use of coding. In such coding, often several code classes are applicable to each record. Also, multiple codes from a single code class may apply to each record. Common code classes include ICD10, CPT, HCPCS, etc. Professional human coders study and use the applicability criteria for codes in such coding work. Typically, records generated at a healthcare provider are manually coded together with simple computer use or the more complex CAC help. Coded records are usually submitted for insurance reimbursement. Typically, insurance reimbursement is based on the codes assigned to a record. In such applications, accuracy is important, where accuracy means the assignment of one or more codes to a record based on matching of the applicability criteria for the assigned codes with the contents of the record. High accuracy means that the assigned codes have their applicability criteria closely matched with the content of the record being categorized. High accuracy and high speed of the coding activity are important business needs for medical coding.

IIb: Automotive “warranty coding” exemplifies another business use of coding. In such coding, a vehicle repair record is assigned certain codes. Often, several code classes are applicable to each record. Also, multiple codes from a single code class may apply to each record. The codes and the code classes usually depend on the vehicle manufacturer. Repair records generated at a vehicle repair location are coded in this manner, and coded repair records are then referred to as warranty claims. Search utilities are currently used for such coding. The coded repair records are usually submitted to the vehicle manufacturer for warranty reimbursement. Typically, warranty reimbursement is associated with the codes assigned to a record. High accuracy, where accuracy is similarly described as for medical coding in paragraph IIa above, and high speed of coding are significant business needs for such warranty coding.

IIIa: CAC continues to be explored for high accuracy and high speed in coding efforts. For instance, a typical approach for CAC in medical coding has been as follows. For a given record and code class, the computer suggests an applicable code. Typically, some combination of “natural language processing” and classification techniques are used to generate such computer-suggested codes. The expectation and hope has been that such computer-suggested codes will have high accuracy and speed up the coding activity. Accuracy may be gauged with help from human expert manual coder. To gauge accuracy, the codes assigned by human expert manual coders are assumed to be 100% accurate, and the codes the human-assigned codes are compared to the computer-suggested codes. The percentage of records with matching human-assigned and computer-suggested codes is assessed. This match percentage helps to measure the accuracy of the computer-suggested codes. Note that different human expert manual coders may differ in terms of what codes each may assign to a particular record, and also, a code or codes assigned to a record may differ in terms of how well their applicability criteria match the contents of that record. These differences notwithstanding, the terms “accurate” and “accuracy” as used herein for computer-suggested codes can be regarded to be essentially based on comparing human-assigned and computer-suggested codes as discussed in this paragraph IIIa. Other variations to measure the accuracy of computer-suggested codes are certainly possible. The current CAC techniques have intended for coding speed and accuracy to increase roughly in proportion to the accuracy of the computer-suggested codes. Speed and accuracy increase expectations are usually based on an intended reduction of the manual coding effort. For instance, it has been hoped that only records with mismatched human-assigned and computer-suggested codes would need full-fledged manual coding.

IIIb: However, CAC has had limited success in increasing coding accuracy and speed. An important reason, and perhaps the main one, for the limited success may be explained as follows: Almost all categorization business applications under consideration need near-100% accuracy. Now, even the best techniques for computer-suggested codes do not achieve near-100% accuracy. The computer use does not help identify records which would have had mismatching human-assigned and computer-suggested codes. And so, considerable manual oversight is required to identify such code-mismatched records. As discussed below, CAC variations have been attempted, but often, the benefits from the variations have not been sufficient to provide a better recourse to manual coding.

IIIc: CAC variations have been considered to circumvent problems such as is described in paragraph IIIb. One variation separates the records into several types that are differentiated based on their expected accuracy for computer-suggested codes. Manual coding may be avoided for records for a type with near-100% expected accuracy, where the records are coded using the computer-suggested codes without manual oversight. But manual effort may be unavoidable for records for a type with less than near-100% expected accuracy. This approach relies on gauging the expected accuracies, which can be difficult. More importantly, this approach relies on having the near-100% expected accuracy types represent a large fraction of the records to be coded, whereas such types of records are usually small fraction. As such, this particular approach has limited applicability since it relies on the factors as described. Furthermore, for situations of multiple categorization, the near-100% expected accuracy would usually be required for all the codes to be assigned to the record, which reduces the fraction of records for which manual coding effort may be avoided.

IIId: A somewhat different CAC variation is as follows. Initially consider a situation of single categorization. For each record to be coded, the one single computer-suggested code most likely expected to apply as determined by the computer is presented to a human expert manual coder. The expert validates if the presented code would match a human-assigned code. If the presented code would match, then the computer-suggested code is used. Otherwise, the recourse taken is effectively manual coding. This CAC variation with manual validation often works better than attempting to use the presented computer-suggested code entirely without human oversight. It works well if the presented computer-suggested code can be validated rapidly, and when its accuracy is relatively high so that the recourse to manual coding may be avoided. To illustrate this CAC variation for single categorization, consider A, B, C, . . . , Z to be the available codes, and with A being the accurate code to assign to a particular record. Now, when the presented computer-suggested code happens to be A, this CAC variation speeds up coding. However, if the presented computer-suggested code is other than A, then a slower manual process is required to find the code A to assign to the record.

IIIe: Consider now the CAC variation described in paragraph IIId as may be applied in a situation of multiple categorization. For each record to be coded, the computer-suggested codes most likely to apply together as a set as determined by the computer are presented to a human expert manual coder. Note that the computer-suggested codes are such that the CAC variation expects all those codes to apply. The human expert manual coder assesses which of the presented computer-suggested codes would match a human-assigned set of codes. The presented computer-suggested codes that would match human-assigned codes are retained, just as in the situation of single categorization. For possible additional codes that may be needed for assigning the multiple codes that apply, the recourse taken is effectively manual coding. Again, this CAC variation with manual validation for a situation of multiple categorization works slightly better than attempting to use the computer-suggested codes entirely without human oversight. Also, it works well if the presented computer-suggested codes can be validated rapidly, and when they have relatively high accuracies so that the recourse to manual coding may be avoided. However, just as in case of the CAC variation mentioned in paragraph IIIc for situations of multiple categorization, the high accuracy need applies for all the codes to be assigned to the record. Such high accuracy for all the presented computer-suggested codes is less likely to happen, and leads to manual coding quite often, thereby reducing the efficacy of this CAC variation in situations of multiple categorization. To illustrate this CAC variation for multiple categorization, consider the available codes to be as described above in paragraph IIId. Assuming that A, B, C and D form the accurate set of codes to assign to a particular record, if that same set is computer-suggested and presented, then this CAC variation speeds up coding. However, if a different set of codes, say C, D, E and F, is computer-suggested and presented, then a slower manual process is required to find the codes A and B to be assigned to the record, even though the presented computer-suggested codes C and D are accurate for coding the record in question. Note that manually de-selecting the presented computer-suggested codes E and F usually can be done quite quickly. In general, the transition to requiring manual coding, such as to find codes A and B in the example of this paragraph IIIe, slows down the coding speed. Usually, the chances are smaller for all and only the set of presented computer-suggested codes to be accurate for assigning to a record to be coded. In consequence, manual coding is often required for this CAC variation also.

### BRIEF SUMMARY OF THE DISCLOSURE

In accordance with one or more embodiments, a computer implemented method is disclosed for a situation of single categorization for assisting a user to select one code from a class of available codes for categorization of a record. A typical user of the computer implemented method disclosed is a human expert manual coder having expertise in assigning codes based on their applicability criteria. Each of the available codes represents a category that can be associated with a record. The method includes the steps of: (a) receiving, at the computer system, information on a record to be categorized; (b) determining, by the computer system, a few candidate codes from the available codes, which codes taken together have a high likelihood of meeting the applicability criteria for the record to be categorized, the candidate codes including one or more candidate codes any one of which is selectable by the user to be assigned to the record to complete categorization of the record among other possible candidate codes; (c) presenting, by the computer system, the set of multiple candidate codes to the user to be displayed on a user display for assessment by the user; (d) receiving a user selection input at the computer system when the user selects one code from the set of multiple candidate codes displayed on the user display device as the code to be associated with the record to complete categorization of the record; and (e) assigning, by the computer system, the selected one code from the set of multiple candidate codes to the record to categorize the record. To illustrate this method for single categorization, consider A, B, C, . . . , Z to be the available codes, and with A being the accurate code to assign to a particular record. As is possible with several computer implemented methods, the codes A, B, C etc. with a higher likelihood of being the accurate code can be generated, and such codes usually would include the accurate code A as well. The disclosed computer implemented method is to present to the user multiple such high likelihood codes, say A, B, C etc., one of which would be the accurate code A to assign to the record to be categorized. The user is then able to select quickly the accurate code A among the presented codes to assign to the record to be categorized.

In accordance with one or more embodiments, a computer implemented method is disclosed for a situation of multiple categorization for assisting a user to select two or more codes from a class of available codes for categorization of a record. A typical user of the computer implemented method disclosed is a human expert manual coder having expertise in assigning codes based on their applicability criteria. Each of the available codes represents a category that can be associated with a record. The method includes the steps of: (a) receiving, at the computer system, information on a record to be categorized; (b) determining, by the computer system, a few candidate codes from the available codes that have a high likelihood of meeting the applicability criteria for the record to be categorized, the candidate codes including two or more candidate codes selectable by the user to be assigned to the record to complete categorization of the record among other possible candidate codes; (c) presenting, by the computer system, the candidate codes to the user to be displayed on a user display for assessment by the user; (d) receiving a user selection input at the computer system when the user selects two or more of the candidate codes displayed on the user display device as the set of codes to be associated with the record to complete categorization of the record; and (e) assigning, by the computer system, the selected set of codes to the record to categorize the record. To illustrate this method for single categorization, consider A, B, C, . . . , Z to be the available codes, and with subset A, B and C being the accurate subset of codes to assign to a particular record. As is possible with several computer implemented methods, the set of codes A, B, C, D and more etc. with a higher likelihood of being among the accurate codes can be generated, and such codes usually would include the accurate subset of codes to assign as well. The disclosed computer implemented method is to present to the user multiple such high likelihood codes, say A, B, C, D and more etc., which would also usually include the accurate subset of codes to assign to the record to be categorized. The user is then able to select quickly the accurate subset of codes A, B and C among the presented codes to assign to the record to be categorized.

A computer system in accordance with one or more embodiments includes at least one processor, memory associated with the at least one processor, a display, and computer input and output devices. A program is supported in the memory for assisting a user to select one or more codes from a class of available codes to categorize a record. Each of said available codes represents a category that can be associated with a record. The program contains a plurality of instructions which, when executed by the at least one processor, cause the at least one processor to: (a) receive information on a record to be categorized; (b) determine a set of multiple suggested candidate codes that is a subset of the available codes having a greater likelihood of accurately matching the applicability criteria for the codes for the record than other codes in the set of available codes, the candidate codes including one or more candidate codes selectable by the user to be assigned to the record to complete categorization of the record among other possible candidate codes; (c) present said set of multiple suggested candidate codes to the user to be displayed on a user display for assessment by the user; (d) receive a user selection input when the user selects one or more of said set of multiple candidate codes displayed on the user display device as the code or codes to be associated with the record to complete categorization of the record; and (e) assign said selected one or more of said set of multiple candidate codes to the record to categorize the record.

### BRIEF DESCRIPTION OF THE DRAWINGS

FIG. 1 is a schematic block diagram illustrating an exemplary network in which a computer-assisted coding system in accordance with one or more embodiments may be implemented.

FIG. 2 is a screenshot illustrating an exemplary current computer-assisted coding technique in automotive warranty coding.

FIG. 3 is a screenshot illustrating an exemplary computer-assisted coding technique in accordance with one or more embodiments for automotive warranty coding.

FIG. 4A is a flowchart illustrating a current computer-assisted coding technique.

FIG. 4B is a flowchart illustrating an alternative current computer-assisted coding technique.

FIG. 5 is a flowchart illustrating an exemplary computer-assisted coding technique in accordance with one or more embodiments.

### DETAILED DESCRIPTION

IVa: Various embodiments disclosed herein are directed to CAC utilizing variations of typical coding and search techniques. CAC techniques in accordance with one or more embodiments generate and present multiple candidate codes for assignment. Such computer-suggested multiple codes are presented for assessment to a human expert manual coder in ways that are easy to examine rapidly. For instance, the candidate codes may be listed in ranked order in a single list. The ranked order may reflect the decreasing likelihood of being assessed to match a human-assigned code. As another example, the candidate codes may be presented in a hierarchical structure. The hierarchy enables rapidly locating an appropriate code manually. There are other ways by user interface design to help with the assessment and selection of appropriate code(s) to assign. For example, it helps to highlight sections of a record pertaining to a presented and selected computer-suggested code. These different approaches help enable rapid assessment of the candidate codes by human expert manual coders.

IVb: A CAC technique could show a large number of codes, and potentially all available codes to the human expert manual coder. Considered together, a large number of codes represents arbitrarily near-100% accuracy. In fact, showing all the codes achieves 100% coverage of the codes. As such, this approach of showing all the codes also trivially represents being able to suggest and present the accurate code or codes with 100% certainty. Of course, the shown codes may not fit a typical computer display. And so, techniques from the display of search results, as an embodiment, are incorporated. Hierarchical structure and ranked order means of display mentioned in paragraph IVa above are examples. CAC techniques in accordance with one or more embodiments work well to speed up coding activity. Among the reasons is that in a CAC technique in accordance with one or more embodiments, presented computer-suggested codes can be assessed rapidly in many situations. This assessment was mentioned in paragraphs IIId and IIIe above, where CAC variations are described. In the paragraphs IIId and IIIe CAC variations, a mismatch assessment leads to manual coding. In contrast, a CAC technique in accordance with one or more embodiments provides a next candidate code to the human coder rapidly upon a mismatch assessment. CAC techniques in accordance with one or more embodiments keep users from having to perform full-fledged manual coding to the extent desired and feasible by the available means to display, navigate, assess and select from a large number of candidate codes efficiently. The number, when relatively small, of computer-suggested codes presented is generally inversely related to the likelihood of requiring typical manual coding. If the candidate codes shown do not include the appropriate codes, then a fallback recourse may be taken such as to use simple computer search utilities with manual coding.

IVc: CAC techniques in accordance with one or more embodiments can benefit from better computer-suggested codes. In CAC, the sooner that the human expert manual coder encounters an accurate candidate code, the better. CAC techniques in accordance with one or more embodiments can be incorporated into the CAC variation of paragraph IIIc as follows. The high expected accuracy type records need not involve any manual effort as described in paragraph IIIc. The remaining type of records requiring manual effort may instead be processed by CAC techniques in accordance with one or more embodiments. In general, CAC techniques in accordance with one or more embodiments apply to any technique set up as described in paragraphs IVa and IVb above.

IVd: The following are two exemplary classification techniques that can be used in CAC in accordance with one or more embodiments. First, with k-nearest-neighbor (kNN) classification, let the class-labels represent the codes used in the CAC. For each record, we use the k most similar already coded records. The codes assigned to these similar records and their frequencies are calculated. Then, these codes are suggested to the user in the non-increasing order of their frequencies. The order here exemplifies the ranked order mentioned in paragraph IVa above. A larger k increases coverage of the codes as described in paragraph IVb above. Second and more generally, multi-label classification techniques may be used. Again, let the class-labels represent the codes in a CAC technique in accordance with one or more embodiments. A multi-label classification may generate multiple codes for a record. The multiple codes may be presented as computer-suggested candidate codes. To get 100% code coverage, the remaining codes may also be shown. But these remaining codes should be ranked lower than the candidate codes.

IVe: The user interface should also be designed to enable the user to view, navigate, assess and make code selections easily and efficiently. Besides approaches which may use pointing devices, any other means of indicating a selection, such as by voice, gesture, or some indirect mechanisms, may also be used.

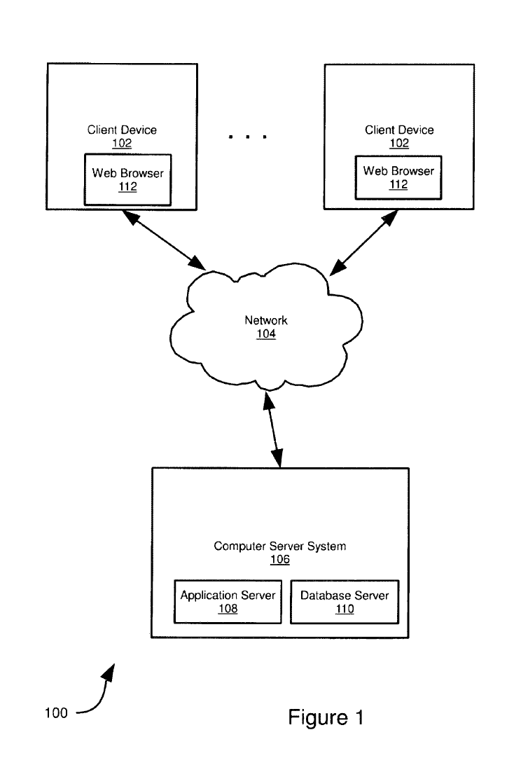

FIG. 1 illustrates an exemplary system 100 for CAC in accordance with one or more embodiments. The system 100 includes a plurality of client devices 102 used by users (e.g., human expert manual coders) to select codes to categorize records. Each of the client devices 102 is connected via a network 104 to a computer server system 106.

The computer server system 106 includes an application server 108 and a database server (or any type of information storage and retrieval system) 110. The application server 108 receives information on records to be categorized and determines a set of multiple suggested candidate codes for users based on information stored in the database 110 on available codes, including criteria for each code. In addition, the database 110 can store information on previously coded records for potential use in categorizing new records that need to be coded. The multiple suggested candidate codes determined by the computer server system 106 are returned to the users over the network 104 to be displayed to the users for assessment and selection by the users on the client device 102.

The computer server system 106 may comprise one or more physical machines, or virtual machines running on one or more physical machines. In addition, the computer server system 106 may comprise a cluster of computers or numerous distributed computers that are connected by a network or the internet.

The client devices 102 operated by the users may, e.g., be personal computers such as a Pentium®-based desktop, laptop, or tablet computers running a Windows® operating system. The client devices 102 can also be smartphones or other mobile communication devices. The client devices 102 include a display interface (a graphical user interface) and associated input devices (e.g., a keyboard, touch-sensitive screen, and mouse or other pointing device). The client devices 102 can include a browser 112, which can be any of a variety of Web browsers including, e.g., the Google Chrome® and Mozilla Firefox® Web browsers.

The network 104 may, e.g., be the Internet, an intranet, or other network connection.

In the system 100 described above, users operating client devices 102 can remotely access the computer server system 106 over the network 104. The computer server system 106 transmits a set of multiple suggested candidate codes for each record to be coded to the user over the network 104 to be displayed on the client device 102. The coders may accordingly be located at a different physical location from the computer server system 106.

In accordance with one or more alternate embodiments, the system for CAC is implemented in a stand-alone (i.e., non-network based) computer system operated by the user. In this case, the same physical or virtual computer system operated by the user performs the functions of determining multiple suggested candidate codes and displaying the results to the user for assessment.

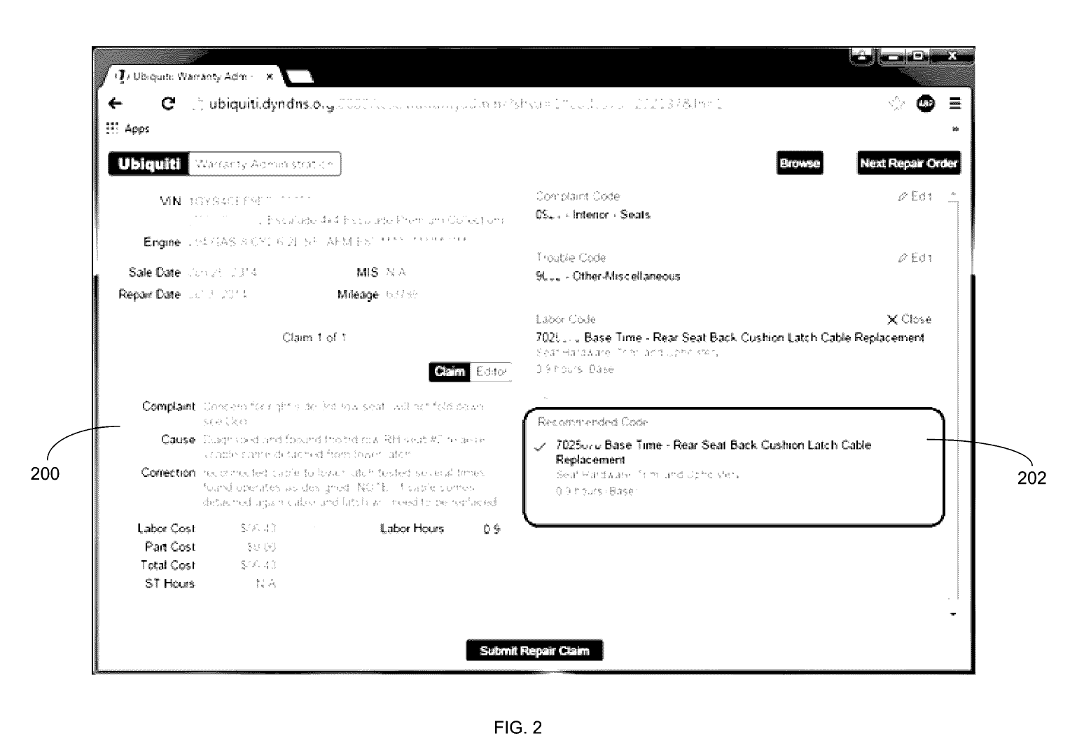

VI: A screenshot showing an example use of a current approach is shown in FIG. 2. FIG. 2 shows the record 200 to be coded. Also in the figure, out of many possible computer-suggested codes, one code 202 determined by the computer to be the most likely to apply is displayed to the user. Since 100% accuracy is very unlikely, the displayed code must be assessed by the user. If the displayed code is assessed to be not accurate, then manual coding is needed. FIG. 2 is a screenshot of an exemplary interface for automotive warranty coding. A candidate “Labor Code” 202, as assigned in warranty coding, is shown outlined at the right side of the screen.

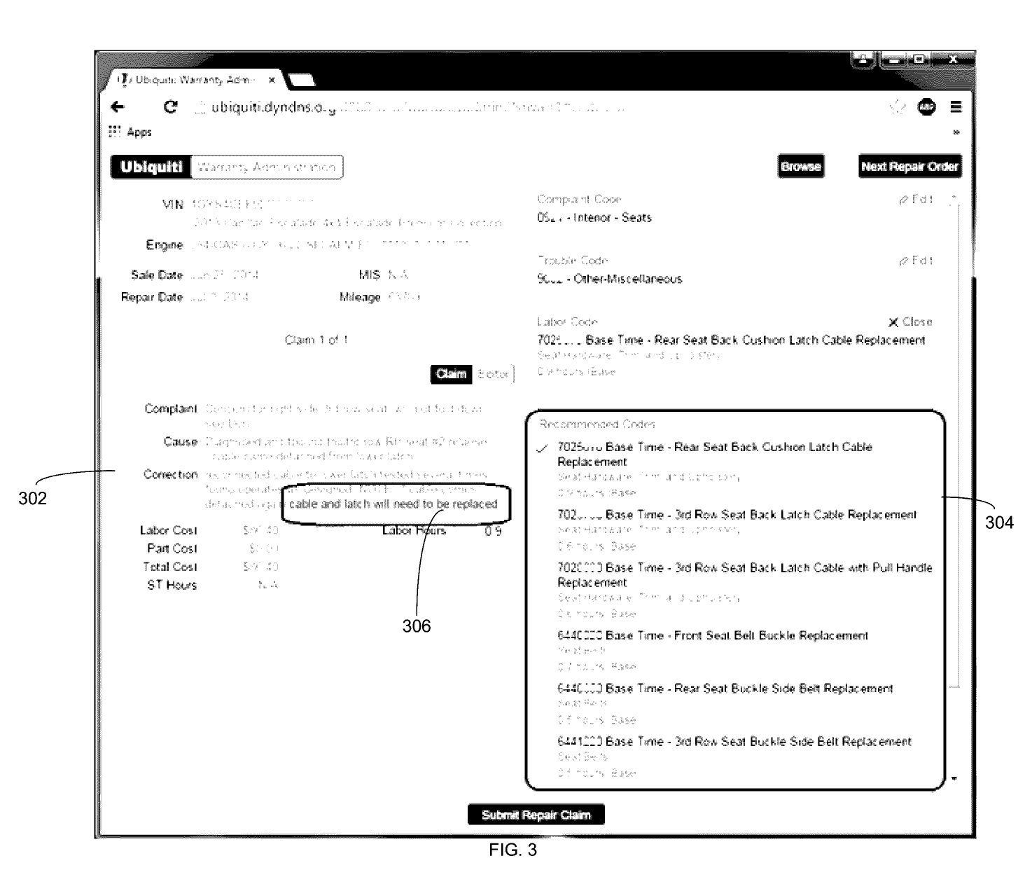

FIG. 3 is a screenshot illustrating a CAC technique in accordance with one or more embodiments. A record 302 to be coded is shown in the left side of the screen. As outlined at the right in the figure, several CAC codes 304 are suggested for display. The computer-suggested codes happen to be displayed in a ranked order in a single list in this example. The ranked order may be evaluated by any appropriate technique or heuristic. Automated highlighting of relevant sections of the record is also shown at 306. The highlighting of sections helps the user to assess each displayed computer-suggested code rapidly. By displaying several or all the codes, arbitrarily close to 100% coverage of codes is possible.

In accordance with one or more alternate embodiments, the computer-suggested codes are displayed in a hierarchical order. In one exemplary embodiment, the hierarchical order has an inverted tree structure.

In accordance with one or more alternate embodiments, the computer-suggested codes are organized in clusters for assessment by the user. Clustering can be based on responses to questions posed to the user to narrow down the set of suggested candidate codes. The clusters can be nested, enabling the user to navigate through multiple levels of clusters. The clusters themselves can also be displayed to users in ranked order.

In accordance with one or more embodiments, a search interface is provided enabling the user to perform search on a large set of computer-suggested codes.

In accordance with one or more embodiments, the user selects two or more of the set of multiple candidate codes to categorize the record. The set of multiple suggested codes can be presented to the user in groups of two or more suggested codes likely to be selected together by the user. The set of multiple suggested codes can also be presented to the user in a single group containing all the suggested codes shown together.

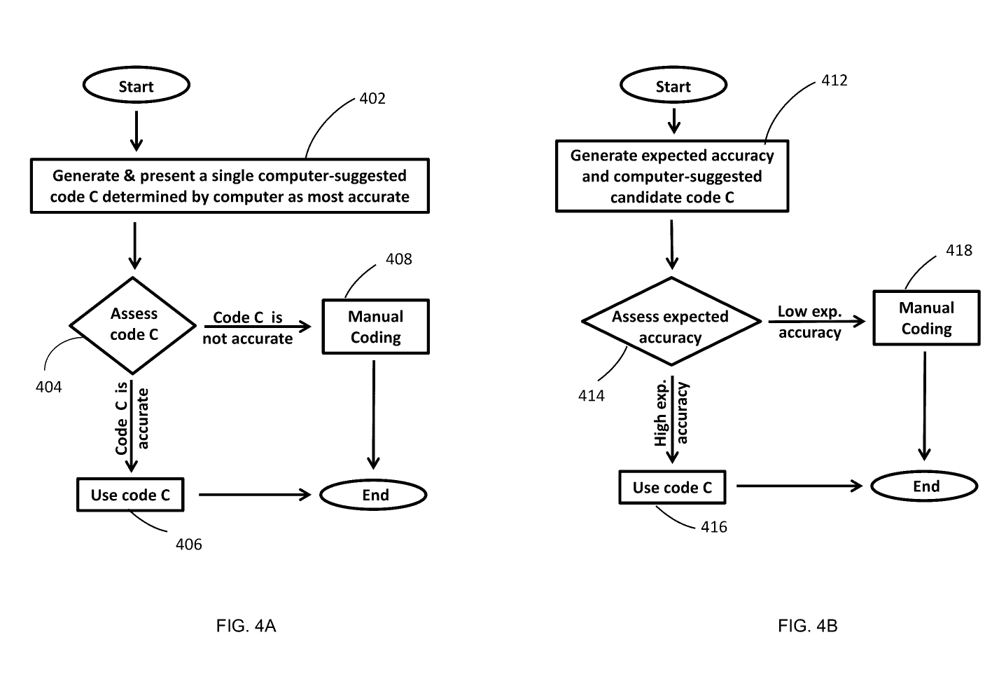

VII: Flowcharts illustrating steps in example current approaches for CAC are shown in FIGS. 4A and 4B. The steps shown are for the coding of each record. In FIG. 4A, a single computer-suggested code determined by the computer to be most likely accurate is generated and presented in step 402. It is assessed manually in step 404 by a user. If the computer-suggested code is assessed to be accurate, then it is used in step 406. Otherwise, manual coding is the recourse shown in step 408.

In FIG. 4B, the expected accuracy of the record type and the computer-suggested code are generated in step 412. The expected accuracy is assessed programmatically in step 414. If the expected accuracy is high, then the computer-suggested code is used in step 416. Else, the expected accuracy is low, and manual coding is the recourse taken in step 418. Note that the computer-suggested code generation may be postponed until after the expected accuracy is assessed to be high, but since computational costs are small, it does not impact coding speed much in practice.

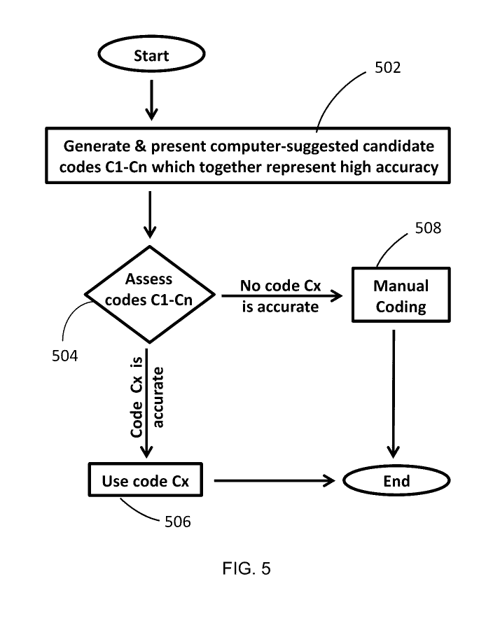

VII: FIG. 5 is a flowchart illustrating a CAC technique in a situation of single categorization in accordance with one or more embodiments. Again, the flowchart represents the steps to be taken for coding each record. As shown, several computer-suggested codes C1-Cn, which together represent high accuracy, are generated and presented to the user in step 502, e.g., in ranked order (not shown in the flowchart). The codes are assessed manually in step 504. If a code Cx is deemed to be accurate, then it is used in step 506. Else, when none of the codes generated is accurate or more codes other than those computer-suggested and presented are deemed necessary, manual coding is the recourse in step 508.

The processes described above may be implemented in software, hardware, firmware, or any combination thereof. The processes are preferably implemented in one or more computer programs executing on a programmable computer system including a processor, a storage medium readable by the processor (including, e.g., volatile and non-volatile memory and/or storage elements), and input and output devices. Each computer program can be a set of instructions (program code) in a code module resident in the random access or other memory of the computer system. Until required by the computer system, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network. Similarly, users of CAC techniques in accordance with one or more embodiments may be situated in locations geographically different from the location of the computer system components.

Accordingly, the foregoing description and attached drawings are by way of example only, and are not intended to be limiting.

What is claimed is:

1. A computer implemented method of assisting a user to select one or more codes from a set of available codes to categorize a record, each of said available codes representing a category that can be associated with a record, the method comprising the steps of:
(a) receiving, at the computer system, information on a record to be categorized;
(b) determining, by the computer system, a set of multiple candidate codes to suggest to the user that is a subset of the set of available codes having a greater likelihood of accurately matching applicability criteria for the codes for the record than other codes, said set of multiple candidate codes including one or more candidate codes selectable by the user to be assigned to the record to complete categorization of the record among other possible candidate codes;
(c) presenting, by the computer system, said set of multiple suggested candidate codes to the user to be displayed on a user display for assessment by the user;
(d) receiving a user selection input at the computer system when the user selects one or more of said set of multiple candidate codes displayed on the user display device among other possible candidate codes as the code or codes to be associated with the record to complete categorization of the record; and
(e) assigning, by the computer system, said selected one or more of said set of multiple candidate codes to the record to categorize the record.

2. The method of claim 1, wherein step (b) further comprises organizing the set of multiple suggested candidate codes in a computed order or in clusters, and wherein step (c) comprises presenting said set of multiple suggested candidate codes to the user in a single list in said computed order or in an arrangement of clusters for assessment by the user.

3. The method of claim 2, wherein said computed order of said set of multiple suggested candidate codes comprises a ranked order based on a likelihood of being selected by the user.

4. The method of claim 2, wherein said computed order comprises a hierarchical order.

5. The method of claim 4, wherein said hierarchical order has an inverted tree structure.

6. The method of claim 2, wherein organizing the set of multiple suggested candidate codes in a computed order or in clusters is based on user-feedback or by tracking often-used codes.

7. The method of claim 2, wherein organizing the set of multiple suggested candidate codes in clusters is based on responses to questions posed to the user to narrow down the set of suggested candidate codes.

8. The method of claim 2, wherein the clusters are nested, enabling the user to navigate through multiple levels of clusters.

9. The method of claim 2, wherein the clusters are displayed in ranked order.

10. The method of claim 1, further comprising providing a search interface enabling the user to search the set of multiple suggested candidate codes.

11. The method of claim 1, wherein said user selects two or more of said set of multiple candidate codes to categorize the record, and wherein step (c) comprises presenting said set of multiple suggested codes to the user individually or in groups of two or more suggested codes likely to be selected together by the user.

12. The method of claim 1, wherein said record comprises a medical record to be coded for insurance reimbursement or a product repair record to be coded for warranty reimbursement.

13. The method of claim 1, wherein step (b) is performed by calculating the similarity of the record to be categorized to other records previously categorized and ranking codes assigned to said other records based on the similarity of the other records to the record to be categorized.

14. The method of claim 13, wherein the similarity of the record to be categorized to other records is calculated using a classification technique.

15. The method of claim 1, wherein the computer system is a remote computer system accessible by a client device operated by the user over a computer network.

16. The method of claim 1, wherein the computer system is a stand-alone computer system operated by the user.

17. The method of claim 1, wherein step (c) further comprises presenting, by the computer system, one or more highlighted sections of the record relevant to the set of multiple suggested candidate codes to the user to be displayed on the user display for use in assessing the multiple suggested candidate codes.

18. A record categorized by one or more codes as determined by the method of claim 1.

19. A computer assisted method of selecting one or more codes from a set of available codes to categorize a record, each of said available codes representing a category that can be associated with a record, the method comprising the steps of:
(a) receiving at a computer system operated by a user, a set of multiple candidate codes determined by another computer system to suggest to the user that is a subset of the set of available codes having a greater likelihood of accurately matching applicability criteria for the codes for the record than other codes, said set of multiple candidate codes including one or more candidate codes selectable by the user to be assigned to the record to complete categorization of the record among other possible candidate codes;
(b) displaying said set of multiple suggested candidate codes to the user for assessment by the user on a user display of the computer system operated by the user;
(c) receiving a user selection input at the computer system operated by the user identifying one or more of said set of multiple candidate codes displayed on the user display device as the code or codes to be associated with the record; and
(d) assigning, by the computer system operated by the user, said selected one or more of said set of multiple candidate codes to the record to categorize the record.

20. A computer system, comprising:
at least one processor;
memory associated with the at least one processor;
a display;
computer input and output devices; and
a program supported in the memory for assisting a user to select one or more codes from a set of available codes to categorize a record, each of said available codes representing a category that can be associated with a record, the program containing a plurality of instructions which, when executed by the at least one processor, cause the at least one processor to:
(a) receive information on a record to be categorized;
(b) determine a set of multiple suggested candidate codes that is a subset of the set of available codes having a greater likelihood of accurately matching applicability criteria for the codes for the record than other codes in the set of available codes, said set of multiple candidate codes including one or more candidate codes selectable by the user to be assigned to the record to complete categorization of the record among other possible candidate codes;
(c) present said set of multiple suggested candidate codes to the user to be displayed on a user display for assessment by the user;
(d) receive a user selection input when the user selects one or more of said set of multiple candidate codes displayed on the user display device as the code or codes to be associated with the record; and
(e) assign said selected one or more of said set of multiple candidate codes to the record to categorize the record.

21. The computer system of claim 20, wherein the computer system comprises a computer server system accessed remotely by a client device operated by the user over a network.

22. The computer system of claim 20, wherein the computer system comprises a stand-alone computer operated by the user.

23. A computer program product for assisting a user to select one or more codes from a set of available codes to categorize a record, each of said available codes representing a category that can be associated with a record, the computer program product residing on a non-transitory computer readable medium having a plurality of instructions stored thereon which, when executed by a computer processor, cause that computer processor to:
(a) receive information on a record to be categorized;
(b) determine a set of multiple suggested candidate codes that is a subset of the set of available codes having a greater likelihood of accurately matching applicability criteria for the codes for the record than other codes in the set of available codes, said set of multiple candidate codes including one or more candidate codes selectable by the user to be assigned to the record to complete categorization of the record among other possible candidate codes;
(c) present said set of multiple suggested candidate codes to the user to be displayed on a user display for assessment by the user;
(d) receive a user selection input when the user selects one or more of said set of multiple candidate codes displayed on the user display device as the code or codes to be associated with the record; and
(e) assign said selected one or more of said set of multiple candidate codes to the record to categorize the record.
